(19) United States
(12) Patent Application Publication
(10) Pub. No.: US 2026/0016335 A1
(43) Pub. Date: Jan. 15, 2026

(54) METHOD FOR ADAPTING AN APERTURE GEOMETRY OF AN APERTURE OF AN APERTURE DIAPHRAGM TO A BEAM PATH OF LIGHT BEAMS IN A SPECTROMETER

(71) Applicant: Analytik Jena GmbH+Co. KG, Jena (DE)

(72) Inventors: Michael Okruss, Potsdam (DE); Stefan Münch, Berlin (DE); Marco Braun, Jena (DE)

(21) Appl. No.: 19/262,658

(22) Filed: Jul. 8, 2025

(30) Foreign Application Priority Data
Jul. 15, 2024 (DE) 10 2024 120 015.4

(51) Int. Cl. G01J 3/02; G01J 3/28

(52) U.S. Cl. CPC G01J 3/0237; G01J 3/28

(57) ABSTRACT

A method for adapting an aperture geometry of an aperture of an aperture diaphragm to a beam path of light beams in a spectrometer includes providing an optical model that describes the beam path and that includes the optical components and their positions and orientations, wherein the optical model includes a first free parameter set that describes the aperture geometry and that includes a plurality of first free parameters, establishing a quality function that comprises at least one quality criterion of the beam path and is embodied to calculate a quality measure based on the optical model, inserting a plurality of sets of values for the first free parameter set and calculating the quality measure for each set of values, and determining the aperture geometry by selecting that set of values of the first free parameter set for which the lowest value of the quality measure was calculated.

### CROSS-REFERENCE TO RELATED APPLICATION

The present application is related to and claims the priority benefit of German Patent Application No. 10 2024 120 015.4, filed Jul. 15, 2024, the entire contents of which are incorporated herein by reference.

### TECHNICAL FIELD

The present disclosure relates to a method for adapting an aperture geometry of an aperture of an aperture diaphragm to a beam path of light beams in a spectrometer, wherein the spectrometer comprises the aperture diaphragm, a plurality of optical components and a detector, wherein the optical components are arranged and embodied in such a manner that they lead the beam path of the light beams from a light source to the detector, wherein the detector is embodied to detect the light beams in the form of a spectrum. The present disclosure relates further to a method for producing an aperture diaphragm having an aperture, whose aperture geometry is adapted to a beam path of light beams in a spectrometer, and to a spectrometer comprising a plurality of optical components, a detector and an aperture diaphragm.

### BACKGROUND

Aperture diaphragms are regularly applied in spectrometers, in order to fix the beam geometry of the light beams, in that they let a part of the light beams pass to the subsequent beam path and block another part. For this, they have an, often black, frame area with an aperture through which the light beams can pass. The aperture can have different aperture geometries. Conventional aperture geometries have, for example, circular, elliptical or rectangular forms. Aperture diaphragms are frequently arranged before an entrance slit of the spectrometer, i.e. at a point where the light beams are not yet spectrally separated. They can, however, also be arranged at other positions of the beam path. Since the aperture diaphragm determines the beam geometry of the light beams, it contributes to a high degree to the determining of the geometric light throughput (etendue) of the spectrometer. Additionally, the aperture diaphragm determines together with the focal length of the imaging system the aperture ratio of the system and has a large influence on image defects. By choice of the aperture diaphragm and, especially, the aperture geometry, thus, different spectrometer characteristics can be influenced greatly. The conventional aperture geometries are, however, regularly not suitable for the beam path present in the spectrometer, such that the advantages of the aperture diaphragm as regards image defects, among others, cannot be optimally utilized.

### SUMMARY

An object of the present disclosure is, consequently, to provide a method and a spectrometer enabling an adapting of an aperture geometry to a beam path.

The object is achieved according to the present disclosure by a method for adapting an aperture geometry of an aperture of an aperture diaphragm to a beam path of light beams in a spectrometer as defined in claim 1, a method for producing an aperture diaphragm as defined in claim 13 and a spectrometer as defined in claim 14.

According to the present disclosure, the object is achieved by a method for adapting an aperture geometry of an aperture of an aperture diaphragm to a beam path of light beams in a spectrometer, wherein the spectrometer comprises the aperture diaphragm, a plurality of optical components and a detector, wherein the optical components are arranged and embodied in such a manner that they lead the beam path of the light beams from a light source to the detector, wherein the detector is embodied to detect the light beams in the form of a spectrum, wherein the method comprises steps as follows:
providing an optical model which describes the beam path and comprises the optical components as well as their positions and orientations, wherein the optical model includes a first free parameter set, which describes the aperture geometry and comprises a plurality of first free parameters,
establishing a quality function, which comprises at least one quality criterion of the beam path, wherein the quality function is embodied to calculate a quality measure based on the optical model,
inserting a plurality of sets of values for the first free parameter set in the optical model and calculating the quality measure for each set of values, and
determining the aperture geometry by selecting that set of values, for which the lowest value of the quality measure was calculated.

The method of the present disclosure enables, thus, an adapting of the aperture geometry to the beam path in the spectrometer. For such purpose, firstly, an optical model is provided, in which the position and orientation of the optical components is specified and the beam path of the light beams is defined. Also an area shape of the optical components can be specified in the optical model. The optical model can comprise a mathematical description of the locations and orientations of the optical components and, based on that, the beam path calculated. The optical model includes supplementally a first free parameter set for the aperture geometry. The first free parameter set includes a plurality of free first parameters, i.e. two or more first free parameters. No fixed values are associated with or specified for the plurality of first free parameters, but, instead, the values of the first free parameters are ascertained, or optimized, by means of the method of the present disclosure. Optionally, one or more boundary conditions can be specified for the first free parameters, such as, for example, minimum- or maximum values.

Additionally, a quality function is created which serves for calculating a quality measure. The quality measure is calculated based on the optical model. The quality function can be embodied to apply the optical model for computing the quality measure. The quality function can calculate the at least one quality measure based on the optical model and taking into consideration the at least one quality criterion. In such case, the quality function can be embodied to check to what extent the optical model, and the beam path, fulfills the at least one quality criterion and, based on such condition, to calculate the quality measure. The quality function is especially embodied in such a manner that lower values of the calculated quality measure mean a greater fulfillment of the at least one quality criterion, while higher values of the calculated quality measure mean a lower fulfillment of the at least one quality criterion. The quality function can also be embodied in such a manner that greater values of the calculated quality measure mean a greater fulfillment of the at least one quality criterion, while lower values of the calculated quality measure mean a lower fulfillment of the at least one quality criterion. The at least one quality criterion can describe a spectrometer characteristic or a spectrometer property. Especially selected as the at least one quality criterion is a spectrometer characteristic having a large influence on the dimensions of the spectrometer or on the spectrum.

Then, the values of the first free parameter set are varied, in that a plurality of sets of values for the multiple first free parameters are inserted into the optical model. In such case, a first set of values for each of the multiple first free parameters can each have a first value. The first values of the first free parameters can be identical or different for the first free parameters. After inserting the first set of values, the quality measure is calculated by means of the quality function. In a next step, a second set of values for the first free parameters can be inserted and the corresponding quality measure recalculated, and so on. For applied sets of values of the multiple first free parameters, in each case, a quality measure is calculated by means of the quality function. Finally, that set of values is selected for which the lowest quality measure was calculated. Based on the selected set of values of the first free parameter set, the aperture geometry is determined. In the case, in which the quality function is embodied in such a manner that greater values of the calculated quality measure mean a greater fulfillment of the at least one quality criterion, those values of the first free parameter set are selected, for which the largest quality measure was calculated.

The plurality of sets of values for the first free parameter set can be randomly selected or determined by means of various methods. Possible methods for determining values of the first free parameter set are local optimizing methods, such as, for example, Nelder-Mead, damped least squares, gradient descent or orthogonal descent, wherein especially hill climbing, or downhill-search methods are applied, or global optimization algorithms (e.g. with randomized selecting of the start parameter). Also, a combination of global and local methods is possible.

The first free parameter set can describe the aperture geometry mathematically in the form of a single curve or in the form of a plurality of joined curves, for example, a spline. The one or more curves form, in such case, a closed shape or a plurality of closed shapes. The terminology closed shape means a shape whose periphery is a continuous, non-interrupted line. A spline of n-th degree is a function sectionally composed of polynomials of, at most, n-th degree. Especially, use of a spline results in a plurality of first free parameters in the first free parameter set.

A mathematical description of the aperture geometry can also be obtained by means of a function in polar coordines for a radius r and angle θ in the value range [0,2π], wherein r=f(θ). The function can e.g. be of the form

$$f ( r , θ ) = m \cdot ( 1 + ρ ( θ ) ) ,$$

and describe a deviation from the scaled unit circle, wherein m is a scaling factor. The function must fulfill the following ancillary conditions:

$$ρ ( θ ) > - 1 ; ∀ θ . \qquad 1$$

$$ρ ( 0 ) = ρ ( 2 π ) . \qquad 2$$

A possible description for ρ(θ) is a Fourier-series expansion of the form:

$$ρ ( θ ) = {\sum }_{i = 1}^{n} {a}_{i} \cdot sin ( i \cdot θ ) + {\sum }_{i = 1}^{n} {b}_{i} \cdot cos ( i \cdot θ ) with i , n ϵℕ$$

The coefficients (aᵢ, bᵢ) and the scaling factor m are to be determined and form the first free parameter set.

In an embodiment, a single aperture or an aperture composed of a plurality of mutually spaced parts is determined as aperture geometry. The determined aperture geometry can, thus, be a monolithic area or a plurality, i.e. two or more areas, separated from one another.

In a further development, the aperture diaphragm is arranged at a position of the beam path, where the light beams are spectrally separated or not spectrally separated. If the aperture diaphragm, for example, neighbors the slit, then, as a rule, the light beams are not yet spectrally separated at the location of the aperture diaphragm. If the aperture diaphragm is arranged, for example, after a grating or nearer to the detector, then the light beams can be spectrally separated at the location of the aperture diaphragm. In this case, due to the separating of the light beams as regards their wavelengths, it is possible, in given cases, to achieve an especially good adapting of the aperture geometry as regards image defects.

Preferably, the aperture diaphragm is arranged in the beam path before or behind a slit of the spectrometer. The slit can be an entrance slit of the spectrometer. Preferably, the aperture diaphragm is arranged neighboring the slit. An optical component, for example, a mirror, can be arranged between the slit and the aperture diaphragm. Preferably, the aperture diaphragm is arranged before the slit in the beam path to the detector.

In a further development, the optical model includes a second free parameter, which describes a position of the aperture diaphragm in the beam path, wherein a plurality of sets of values for the first free parameters and the second free parameter are applied and the quality measure for each set of values is calculated, wherein the aperture geometry and the position of the aperture diaphragm are determined by selecting that set of values of the first free parameters and the second free parameter, for which the lowest value of the quality measure was calculated. In the case in which the quality function is embodied in such a manner that greater values of the calculated quality measure mean a greater fulfillment of the at least one quality criterion, then, in such embodiment, that set of values for the first free parameter and the second free parameter are selected for which the highest quality measure was calculated.

In an alternative embodiment, a position of the aperture diaphragm is predetermined in the optical model. The position of the aperture diaphragm is therewith defined and not included as a free parameter in the optical model.

Preferably used as the at least one quality criterion is a quality criterion for a spectrometer-geometry, a quality criterion for image defects and/or a quality criterion for parasitic beam characteristics. The quality criterion for the spectrometer-geometry concerns especially the dimensions of the spectrometer. In such case, it is advantageous to apply a spectrometer with small dimensions. The quality criterion for image defects concerns especially image defects in the spectrum. Desirable, in such case, is to have as few image defects as possible. The quality criterion for parasitic beam characteristics concerns especially undesired light beams, which affect the spectrum negatively and come, for example, from reflections on optical components.

Preferably the quality function comprises multiple quality criteria of the beam path, wherein the quality function calculates a quality measure based on the optical model and specified weightings of the quality criteria. The expression “multiple quality criteria” means that two or more quality criteria are used. Thus, the quality function can describe a first quality criterion for the spectrometer-geometry, a second quality criterion for image defects and a third quality criterion for parasitic beam characteristics. The multiple quality criteria can be combined by means of an “AND” operation in the quality function.

In an additional embodiment, besides the sequence, also a position and orientation of the optical components are specified in the optical model. The position and orientation of the optical components is therewith determined in the optical model.

In an alternative embodiment, the optical model includes at least a third free parameter for a position, orientation and/or area shape for at least one of the optical components. The position, orientation and/or area shape of the at least one optical component can in the case of the proposed method be determined as the at least third free parameter supplementally to the first free parameters. For example, a third free parameter can be specified for the position of a mirror, a fourth free parameter for the orientation of the mirror, a fifth free parameter for the area shape of a lens, etc. In such case, a plurality of sets of values for the first free parameters and for the at least a third free parameter are inserted into the optical model and the quality measure calculated for each set of values, wherein that set of values of the first free parameters and the at least a third free parameter is selected for which the lowest quality measure was calculated.

In an embodiment, used as optical components are mirrors, filters, gratings, prisms and/or lenses.

Preferably used as one optical component is an echelle-grating.

In an embodiment, the spectrometer is an ICP-OES device or an AAS device. ICP-OES stands for “inductively coupled plasma optical emission spectroscopy”. The ICP-OES device is a kind of emission spectroscopy, in the case of which an inductively coupled plasma is used for producing excited atoms and ions which emit electromagnetic radiation with the wavelengths characteristic for a certain element. AAS is for atomic absorption spectroscopy. The AAS is a spectro analytic method for quantitative determining of chemical elements using free atoms in the gaseous condition. Atomic absorption spectroscopy is based on the absorption of light by free ions and molecules. Both the ICP-OES-as well as also the AAS device have frequently a high number of optical components and, especially, an echelle-grating. Both devices serve for analysis of samples as regards their atomic composition. The proposed method is especially advantageous for both devices, since, because of the complex beam path, conventional aperture geometries deliver no optimum result as regards the at least one quality criterion.

The object of the present disclosure is achieved, furthermore, by a method for producing an aperture diaphragm having an aperture, whose aperture geometry is adapted to a beam path of light beams in a spectrometer, wherein the spectrometer comprises a plurality of optical components and a detector, wherein the optical components are arranged and embodied in such a manner that they lead the beam path of the light beams from a light source to the detector, wherein the detector is embodied to detect the light beams in the form of a spectrum, wherein the method comprises steps as follows:
determining the aperture geometry according to one of the preceding embodiments,
providing a blank for the aperture diaphragm, and
removing at least one region of the blank corresponding to the determined aperture geometry.

By means of the method of the present disclosure, thus, an aperture diaphragm is obtained, which has the determined aperture geometry. The blank can be, for example, a metal- or plastic part. The removing of the at least one region of the blank, which corresponds to the determined aperture geometry, can occur by means of milling or cutting. Optionally, the blank can be processed before or after the step of removing in such a manner that it has a black surface. Alternatively, the aperture diaphragm can be made by means of an additive production method, such as, for example, 3D printing.

The object of the present disclosure is achieved, furthermore, by a spectrometer comprising a plurality of optical components, a detector and an aperture diaphragm produced according to the method of the preceding embodiment, wherein the optical components are arranged and embodied in such a manner that they lead the beam path of the light beams from a light source to the detector, wherein the detector is embodied to detect the light beams in the form of a spectrum.

In the spectrometer of the present disclosure, thus, an aperture diaphragm is applied whose aperture geometry is adapted to the beam path in the spectrometer.

### BRIEF DESCRIPTION OF THE DRAWINGS

The present disclosure will now be explained in greater detail based on the appended drawing, the FIGS. 1-3 of which show as follows:

FIG. 1 shows a schematic view of a spectrometer of the present disclosure.

FIG. 2 shows a schematic view of the blank and aperture diaphragm.

FIG. 3 shows another view of an aperture diaphragm produced according to the present disclosure.

### DETAILED DESCRIPTION

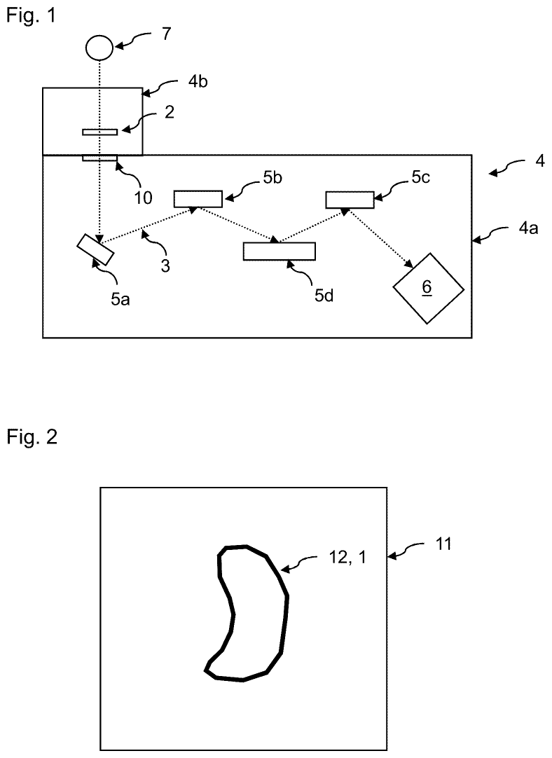

FIG. 1 shows a schematic view of the spectrometer 4 of the present disclosure. Spectrometer 4 comprises a plurality of optical components 5a-5d, an aperture diaphragm 2 and a detector 6. The optical components 5a-5d are arranged and embodied in such a manner that they lead the beam path 3 of the light beam from a light source 7 to the detector 6. Detector 6 is embodied to detect the light beam in the form of a spectrum. Spectrometer 4 can be divided into a plurality of sections, for example, a main region 4a and a front region 4b. Front region 4b can be arranged between the light source 7 and the main region 4a. Front region 4b can be embodied to collect the light beams coming from the light source 7 and to lead them into the main region 4a. Front region 4b can have other optical components, such as, for example, an entrance opening or mirrors or lenses (not shown). Spectrometer 4 can have a slit 10. Slit 10 can be arranged between the main region 4a and the front region 4b. Aperture diaphragm 2 can be arranged neighboring the slit 10. Optical components 5a,5b,5c can be mirrors. The optical component 5d is, by way of example, embodied as an echelle-grating. Other optical components can be filters, prisms and/or lenses. Spectrometer 4 can be an ICP-OES device or an AAS device.

As already described, in the system of the present disclosure, firstly, an optical model is provided which describes the beam path 3 and which has a first free parameter set for the aperture geometry. Additionally, a quality function having at least one quality criterion is created. Then, a plurality of sets of values for the first free parameter set are inserted into the optical model and, for each inserted set of values, the quality measure is calculated. Then, that set of values of the first free parameter set is selected for which the lowest value of the quality measure was calculated, and the aperture geometry determined based on the selected set of values.

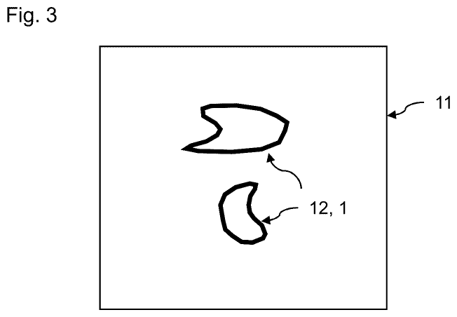

The aperture geometry determined in such a way can be used for producing an aperture diaphragm 2. For such purpose, a blank 11 is provided (compare FIG. 2), in the case of which at least one region 12 is removed, whose shape corresponds to the determined aperture geometry. The at least one region 12 forms then the aperture 1 of the aperture diaphragm 2. The example of the aperture geometry shown in FIG. 2 has a single aperture 1. It is, however, also possible that an aperture 1 composed of a plurality of mutually spaced parts is obtained, such as shown, by way of example, in FIG. 3.

In the optical model, the positions, orientations and area shapes of the optical components can be predetermined. In given cases, also the position of the aperture diaphragm 2 can be predetermined. As a result, the beam path is almost completely defined and only the first free parameter set for the aperture geometry has free parameters in the optical model. Alternatively, it is, however, also possible to insert other free parameters in the optical model. First, a second free parameter can be used to describe the position of the aperture diaphragm 2 in the beam path 3. Furthermore, at least a third free parameter can be used for a position, orientation and/or area shape of at least one of the optical components. The first free parameter set, the second free parameter and the at least a third parameter can be combined with one another to the extent desired. If more free parameters than the first free parameter set are used in the optical model, then, in each case, a plurality of sets of values are inserted for the first free parameter and the one or more additional free parameters and the quality measure calculated for each set of values of the values inserted for the first free parameter set and the one or more additional parameters. The set of values with the lowest calculated quality measure is then selected and, based on such selected combination, the aperture geometry determined.

1. A method for adapting an aperture geometry of an aperture of an aperture diaphragm to a beam path of light beams in a spectrometer, wherein the spectrometer includes the aperture diaphragm, a plurality of optical components, and a detector, wherein the optical components are arranged and embodied in such a manner that they lead the beam path of the light beam from a light source to the detector, wherein the detector is embodied to detect the light beam in the form of a spectrum, the method comprising:
providing an optical model that describes the beam path and includes the optical components as well as their positions and orientations, wherein the optical model includes a first free parameter set having a plurality of first free parameters that describe the aperture geometry;
establishing a quality function that includes at least one quality criterion of the beam path, wherein the quality function is embodied to calculate a quality measure based on the optical model;
inserting a plurality of sets of values for the first free parameter set in the optical model and calculating the quality measure for each set of values; and
determining the aperture geometry by selecting that set of values for the first free parameter set for which the lowest value of the quality measure was calculated.

2. The method as claimed in claim 1,
wherein a single aperture or an aperture composed of a plurality of mutually spaced parts is determined as aperture geometry.

3. The method as claimed in claim 1,
wherein the aperture diaphragm is arranged at a position of the beam path where the light beams are spectrally separated or not spectrally separated.

4. The method as claimed in claim 3,
wherein the optical model includes a second free parameter that describes a position of the aperture diaphragm in the beam path,
wherein a plurality of sets of values for the first free parameter set and for the second free parameter are inserted into the optical model and the quality measure calculated for each set of values, and
wherein the aperture geometry and the position of the aperture diaphragm are determined by selecting that set of values of the first free parameters and the second free parameter for which the lowest value of the quality measure was calculated.

5. The method as claimed in claims 3,
wherein the position of the aperture diaphragm is predetermined in the optical model.

6. The method as claimed in claim 1,
wherein used as the at least one quality criterion is a quality criterion for a spectrometer-geometry, a quality criterion for image defects, and/or a quality criterion for parasitic beam characteristics.

7. The method as claimed in claim 1,
wherein the quality function includes multiple quality criteria of the beam path, wherein the quality function calculates a quality measure based on the optical model and predetermined weightings of the quality criteria.

8. The method as claimed in claim 1,
wherein, besides the sequence, also a position and orientation of the optical components are specified in the optical model.

9. The method as claimed in claim 7,
wherein the optical model includes at least a third free parameter for a position, orientation, and/or area shape for at least one of the optical components.

10. The method as claimed in claim 1,
wherein used as optical components are mirrors, filters, gratings, prisms, and/or lenses.

11. The method as claimed in claim 10,
wherein used as one optical component is an echelle-grating.

12. The method as claimed in claim 1,
wherein the spectrometer is an inductively coupled plasma optical emission spectroscopy (ICP-OES) device or an atomic absorption spectroscopy (AAS) device.

13. A method for producing an aperture diaphragm having an aperture whose aperture geometry is adapted to a beam path of light beams in a spectrometer, wherein the spectrometer includes a plurality of optical components and a detector, wherein the optical components are arranged and embodied in such a manner that they lead the beam path of the light beam from a light source to the detector, wherein the detector is embodied to detect the light beam in the form of a spectrum, the method comprising:
determining the aperture geometry by:
providing an optical model that describes the beam path and includes the optical components as well as their positions and orientations, wherein the optical model includes a first free parameter set having a plurality of first free parameters that describe the aperture geometry;
establishing a quality function that includes at least one quality criterion of the beam path, wherein the quality function is embodied to calculate a quality measure based on the optical model;
inserting a plurality of sets of values for the first free parameter set in the optical model and calculating the quality measure for each set of values; and
determining the aperture geometry by selecting that set of values for the first free parameter set for which the lowest value of the quality measure was calculated;
providing a blank for the aperture diaphragm; and
removing at least one region of the blank corresponding to the determined aperture geometry.

14. A spectrometer, comprising:
a plurality of optical components, a detector, and
an aperture diaphragm,
wherein the aperture diaphragm is produced according to the method as claimed in claim 13,
wherein the optical components are arranged and embodied in such a manner that they lead the beam path of the light beams from a light source to the detector, and
wherein the detector is embodied to detect the light beams in the form of a spectrum. “inductively coupled plasma optical emission spectroscopy”. The ICP-OES device is a kind of emission spectroscopy, in the case of which an inductively coupled plasma is used for producing excited atoms and ions, which emit electromagnetic radiation with the wavelengths characteristic for a certain element. AAS is for atomic absorption spectroscopy.
